(19) United States
(12) Patent Application Publication
(10) Pub. No.: US 2014/0267016 A1
(43) Pub. Date: Sep. 18, 2014

(54) DIGITAL INTERFACE MEDIA

(71) Applicant: James Michael Stavoe, Romulus, MI (US)

(72) Inventor: James Michael Stavoe, Romulus, MI (US)

(21) Appl. No.: 13/845,745

(22) Filed: Mar. 18, 2013

(51) Int. Cl. G06F 3/01

(52) U.S. Cl. CPC G06F 3/017
USPC 345/156

(57) ABSTRACT

A device means which provides a substantially planar writing surface that incorporates the same dimensions, dimensional relationships, and aspect ratios as those used by computer monitors, video display screens and other electronic media. The current invention has components that provide for a direct relationship to the header, margins, composition areas, menus, status bars, and other elements used in many software programs. The translucent properties of the current invention provide the capability for the selective viewing of images, graphics, and data on the front surface, the back surface, or a combination of both surfaces; and, to selectively display elements on the front surface, back surface, or combined surfaces through the manipulation of the light source, or sources, and wavelength(s) of light source(s) utilized.

### CROSS REFERENCE TO RELATED APPLICATIONS

This application claims the benefit of provisional patent application Ser. No. 61/612,432, filed Mar. 19, 2012 by the present inventor.

### FEDERALLY SPONSORED RESEARCH

Not Applicable

### SEQUENCE LISTING OR PROGRAM

Not Applicable

### BACKGROUND OF THE INVENTION

1. Field of Invention

The invention is in the field of information paraphernalia and relates particularly to an attractive, convenient and functional media incorporating translucent properties which provide for the optional combination of front and rear images; and, is designed to utilize the same dimensions, formats, aspect ratios and standards which are used in the electronics industry for computer monitors, tablets, video screens and other electronic display devices.

2. Prior Art

Writing media has been used for millennia. Over the past few centuries paper has been one of the most abundant media used for recording, storing and transferring information. The use of paper in books, newspapers, flyers, and a myriad of other vehicles the format and structure has been primarily used in a portrait orientation.

With the advent of the Information Age has come an explosive growth in electronic media and interfaces which have changed the character of information presentation and recording. Prior to the proliferation of computer monitors, tablets, video screens, personal digital assistants, etc., most written communication took place in a portrait orientation. With the advent of electronic media the format and orientation of information presented in this environment is primarily in a landscape format.

The Current Invention, Digital Interface Media (also referred to as DIM), is designed to create a platform in the physical world which are the same as, align with, utilize, and correspond to the standards used for electronic display devices. By aligning and utilizing the same formats, aspect ratios, configurations, and standards in the Digital Interface Media invention with those utilized in the electronic environment, by computer monitors, video screens, and other electronic display devices, the Digital Interface Media invention drives greater interoperability and improved efficiencies between physical world media and computers, tablets and other electronic display devices.

There are a wide range of products available in the market to fulfill specialized needs, and the market continues to demand improvements in design and performance requirements of writing and recording media. Even with all the recent advancements in physical media technologies, until the present invention there has not been a product with the superior functionality, interoperability, utility, and other characteristics, to provide a useful formatting and recording media that utilizes the same standards as used in the electronic display environment. The present invention is structured to interface, format, design, record, and present information in the same format structure, and to utilize the same standards as those used by electronic media. By using the same orientation, formats, dimensions, aspect ratios, zoning, margining, templating, and other standards as utilized in the electronic media, Digital Interface Media (DIM) creates a more uniform alignment between the Physical World and the Digital Realm. The result is that DIM provides a more efficient and effective interface than any other writing media currently available.

While some media products address specific needs or industries, until the present invention, there has not been a singular product available to record, present, design and format information and images in a landscape format utilizing the same formatting structure and standards that are used by the electronics industry in computer monitors, video screens, and other electronic display devices; and, which also provides for the viewing of a single surface graphic, or the combining of front and rear graphics to create new patterns and images by using the translucent properties of the media.

A variety of inventions and products address some of the issues related to formatting, and providing teaching methodology tools for paper media such as Writing Readiness Paper, Ann M. Jones U.S. Pat. No. 3,638,332, Paper for teaching Writing Skills, Joan Niquette U.S. Pat. No. 4,173,082, and even my WIDE Paper Ser. No. 11/442,931. However, until the current invention none of these inventions provide the features and benefits of Digital Interface Media, Specifically the translucent, multi-graphic, and lighting affect features of Digital Interface Media provide results not addressed by any of these other inventions.

In addition to solving the problem of providing a recording and presentation medium which aligns with electronic devices' formatting, the present invention also increases user efficiency. The current invention utilizes the same dimensions and aspect ratios of most modern electronic devices display screens. As a result, scanned, ‘Full Screen’ images, documents, and information recorded on a sheet of the invention as presented will fit more accurately and completely on computer monitors and electronic displays. Not only will an image more fully utilize the space available on a standard computer screen, or other electronic display device, thereby providing a larger more representative image, but the material recorded on Digital Interface Media invention will more effectively fill the image area of most computer screens, tablets, video projection units, television monitors, and other electronic display devices. Digital Image Media utilizes the same dimensions and aspect ratios as are used by electronic recording and presentation display systems. When images, data, or information which was recorded on the current invention is displayed on an electronic medium, there is less underutilized margin space and representations can be presented at a greater magnification without losing information off the top or bottom of the screen, as is the case using images recorded from ordinary paper or other popular media. Conversely, when using the current invention to record information presented on an electronic display, by utilizing the same standards for the DIM, the character of the information remains intact. Additionally, when formatting data, information, or presentations the user is provided a more accurate representation and can obtain a greater awareness of the final layout and appearance of how it will look when displayed on an electronic device.

Although only a few benefits have been mentioned above, the list of uses and benefits to the user is extensive and not been available with any previous product or device, prior to the present invention.

3. Objects and Advantages

Accordingly, besides the objects and advantages of the present invention described above, several additional objects and advantages of the present invention are:

a) to provide a media that has a multiple recording and display surfaces;

b) to provide a media with graphics that provide for an orderly recording and presentation of information;

c) to provide a media that provides for a landscape orientation in the presentation and recording of information;

d) to provide a media that provides the translucent properties to allow light to be selectively reflected or to penetrate the medium from the user's perspective;

e) to provide a media that provides variable translucent properties along a variety of wavelengths of light energy, and allows light to be selectively reflected or to penetrate the medium selectively along the light wave spectrum from the user's perspective;

f) to provide a media that provides for images on the front and opposite surfaces to be viewed independently or combined through the manipulation of the light source, or light sources;

g) to provide a media that provides for images on the front and opposite surfaces to be viewed independently or combined through the manipulation of the light wave spectrum and of the light source, or sources;

h) to provide a media that has a recording area that utilizes the same formats as are utilized by computer monitors and electronic display devices;

i) to provide a media that has a recording area that utilizes the same dimensions as utilized by computer monitors and electronic display devices;

j) to provide a media that has a recording area that utilizes the same aspect ratios as utilized by computer monitors and electronic display devices;

k) to provide a media that has a recording area that utilizes the same formats as utilized by computer programs;

l) to provide a media that has a recording area that utilizes the same standards as utilized by computer programs;

m) to provide a media that has a recording area that utilizes the same dimensions as utilized by computer programs;

n) to provide a media that has a recording area that utilizes the same aspect ratios as utilized by computer programs;

o) to provide a media that is more ergonomically oriented than current, ordinary, writing media;

p) to provide a media that fits more conveniently in a variety of traditional working environments, such as cubicles and desk tops;

q) to provide a media that fits more conveniently in a variety of extemporaneous work areas, such as an airplane tray tables;

r) to provide a media which fits into presentation systems and binders in a compelling fashion;

s) to provide a media that is compliant with modern educational and office equipment, machinery, filing systems, and other peripherals.

### SUMMARY OF THE INVENTION

The present invention includes a combination of features which make it more useful, effective, efficient, and attractive in providing a medium for formatting, designing, developing, recording, transferring and presenting information than is currently available.

The present invention is sized, shaped and formatted to align with, and utilize, standards used by computer monitors, video display screens and other electronic display devices. Additionally, writing areas, or zones, are formatted to align with header, menu, icon, task panes, rulers, margins and primary work zones utilized by many computer programs.

The current invention is designed and sized to allow the user to design, format, record and present information efficiently and effectively in a horizontal orientation using many of the same formats as utilized by computer monitors, video display screens, other electronic display devices and software programs. Additionally, the footprint of each sheet is engineered to fit into standard binders, files, portfolios, letter boxes, desk trays as well as a myriad of other devices. Digital Interface Media is also designed to allow it to work in most modern office machinery and equipment without requiring updates, modifications, additions, or optional accessories.

The present invention is rectangular in shape in a landscape orientation with the horizontal axis being greater than the vertical axis. Additionally, each sheet contains a plurality of parallel lines oriented along the horizontal, landscape, axis of the page. An additional line, or plurality of lines, graphic, or shading, running from the top to the bottom of the page, along the left side may be used to delineate a margin area.

Specific areas, or zones, of the surface are designated as the header area, margin area, lower margin, and work area. These areas, or zones, align with the locations of the Title Bar, Menu Bar, Task Bar, Icon Bar, Margins, Rulers, Status Bars, Task Panes, Frames and other areas typically displayed on a computer monitor or electronic display screen.

In its preferred embodiment the current invention is constructed of a media in the “paper weight” range of generally in 10 lb.-50 lb. The invention may be constructed of a heavier or lighter weight of depending on the specific application, intended use, purpose, or to meet specific requirements and is not limited to the 10 lb.-50 lb. range.

The front surface of the current invention has a plurality of parallel, horizontally oriented lines, or other patterns, which lend themselves to the orderly recording of information. Additionally, there may be a line, plurality of lines, or shaded area extending vertically near the left margin, for letters, numbers, representations of computer screens, electronic displays, indicators, other indices, or for use a as an empty margin. As indicated the configuration of the indicated lines creates areas, or zones, which are comparable to areas and zones displayed on computer monitors and electronic video displays. These zones or work areas utilize the same structure, aspect ratios, and dimensions as are used in electronic media displays. One of the more common aspect ratios being 4:3.

The front surface of the current invention is preferably of white construction with surface graphics; but, in alternate embodiments the base color may also be of a variety of colors, shades, or pastels. Alternate embodiments may also be embedded with an image or watermark. The opposite surface of the current invention is similar to the front surface and is preferably of white material; but, may also be of a variety of colors, shades, pastels, and contain embedded images or watermarks. On the individual sheet the reverse surface may be of a similar design to the front of the sheet or in alternate embodiments could be blank or have a variety of alternate graphics or images embedded. The material provides sufficient opacity to prevent viewing the backside when it is front lit, but will provide for a level of translucency allowing the graphics or image on the reverse side to be visible from the front when backlit. The combination of the translucency and the variable designs on the front and rear surfaces of the media allows the combination of both front and rear images into a new image, pattern, or structure on the viewing surface when backlit. The clarity and visibility of the reverse side image is controlled by the opacity of the media, which can be varied for different applications. Additionally, the base color of the sheet and the color of the graphic images can be modified to produce different visible results when managing the wavelengths of the frontal and backlit light sources. As an example a red graphic can be rendered not visible through the use of a red wavelength frontal light source. Manipulating the front and backlit light sources, in combination with the color pigmentation of the graphics can be used to manage what aspects of the patterns or images are visible to the user.

As described above with the use of a red light source and red pigmentation in the graphic to mask its visibility, other combinations of lighting color, relative source (i.e. front lit or back lit), and pigment coloration can be used in a variety of combinations to manipulate and change the visual appearance of the Digital Interface Media, its graphics, and the information presented on it.

The construction of the surfaces of the sheet preferably have a flat sheen providing a dull finish that will allow items printed or written on the surface to be easily discernible. Such surface is intended to provide a good writing texture, feel, and provide selective visibility of information recorded on the surface. The material also intends to absorb and dry ink quickly, thereby preventing smudging, smearing and bleeding.

It is therefore among the objects of the invention to provide a useful, efficient, effective, attractive and convenient media, sized and constructed to promote the recording and presentation of information in a landscape format that is consistent with the appearance, formats, and using the same standards used by computer monitors, video screens and electronic display devices. Additionally, through the use of images on multiple surfaces Digital Interface Media provides the user the ability to combine, or render invisible graphics, images, and recorded information by managing their light source and wave length. These and other objects, advantages and features of the invention will be apparent from the following description of a preferred embodiment, considered along with the accompanying drawings.

### DRAWINGS—REFERENCE NUMERALS

FIG. 1 is a frontal view of the current invention.

FIG. 2 is a view of the rear of the current invention in an alternate embodiment with a lateral pattern matched perpendicularly to the pattern on the front side of the sheet.

FIG. 3 is a side view of the current invention demonstrating its narrow nature.

FIG. 4 is a front view of the current invention demonstrating the combined visual effect of the front and rear patterns interacting when light passes through the sheet from the opposite side.

FIG. 5 is a view of the front of the current invention in an alternate embodiment containing denser lineage.

FIG. 6 is a view of the front of the current invention in an alternate embodiment containing a less dense lineage pattern.

FIG. 7 is a view of the current invention with the top margin highlighted.

FIG. 8 is a view of the current invention with the left side margin highlighted.

FIG. 9 is a view of the current invention with the right side margin highlighted.

FIG. 10 is a view of the current invention with the bottom margin highlighted.

FIG. 11 is a view of the current invention with the composition/work area highlighted.

FIG. 12 is a view of a computer program as displayed on an electronic display.

FIG. 13 is a view of a computer program as displayed on an electronic display with the header and menu areas highlighted.

FIG. 14 is a view of a computer program as displayed on an electronic display with the right and left margin areas highlighted.

FIG. 15 is a view of a computer program as displayed on an electronic display with the bottom menu and status bar areas highlighted.

FIG. 16 is a view of a computer program as displayed on an electronic display with the primary work area highlighted

FIG. 17 is a view of the current invention overlaid on an electronic display demonstrating the relationship between the constructed patterns.

FIG. 18 is a view of the current invention overlaid on an electronic display demonstrating the relationship between the constructed patterns with the header and top menu areas highlighted.

FIG. 19 is a view of the current invention overlaid on an electronic display demonstrating the relationship between the constructed patterns with both side margins highlighted.

FIG. 20 is a view of the current invention overlaid on an electronic display demonstrating the relationship between the constructed patterns with the bottom menu and status bar areas highlighted.

FIG. 21 is a view of the current invention overlaid on an electronic display demonstrating the relationship between the constructed patterns with the primary work area highlighted.

FIG. 22 is a view of the current invention with the dimensional axes of the sheet indicated

FIG. 23 is a view of the current invention with the dimensional axes of the primary work area indicated

FIG. 24 is a view demonstrating the relationship between the current invention, an electronic display and the software visual with the dimensional axes of the sheet and the display area of the electronic display indicated.

FIG. 25 is a view demonstrating the relationship between the current invention, an electronic display and the software visual with the dimensional axes of the primary work area created by the software.

FIG. 26 is visual of the primary shapes and aspect ratios (width to height relationships) utilized by electronic display devices.

FIG. 27 is visual of the primary shapes and aspect ratios (width to height relationships) utilized by electronic display devices, presented in a transparent, layered arrangement.

FIG. 28 is visual of the primary aspect ratios utilized by electronic display devices.

FIG. 29 is table presenting the primary aspect ratios, pixel dimensions, and relative frequency of use by electronic display devices.

### DETAILED DESCRIPTION—FIG. 1 THROUGH FIG. 29—AND THE PREFERRED EMBODIMENTS

FIG. 1 of the drawings shows a frontal view of a sheet of the current invention 10 demonstrating its rectangular shape and landscape orientation. On the surface of the preferred embodiment of the current invention 10 are a plurality of horizontal lines 16. Said horizontal lines are parallel and preferably extend across the surface. The front surface of the sheet 10 may also include a line 18, or lines, extending vertically down the height of the page, along the left margin, crossing the horizontal lines 16 as illustrated. An additional line 19, or lines, is indicated along the right hand margin running parallel to the right edge of the sheet. Line 19 may be created by either imprinting it on the surface or by a translucent effect of the media from a line imprinted on the opposite side of the sheet.

The sheet 10 is preferably white in color; however in alternate embodiments a variety colors, pastels, shades, embedded images, graphics, or templates may be utilized.

One embodiment, primarily for North American markets, would provide for an 11 inches width, by approximately 8½ inches in height, by approximately 0.003 inches in thickness to allow the media to be utilized in common American standard office equipment. Utilizing a 1½ inch side margins and a 1¼ inch top and bottom margins would provide for a working area with dimensions of 8 inches by 6 inches and a 4:3 aspect ratio. This is the same aspect ratio utilized in QGA, VGA, PAL, SCGA+ and a variety of other electronic display systems standards.

An alternate embodiment, primarily for markets where metric standards are utilized, would provide for a media with dimensions of 11.7 inches by 8.3 inches by 0.003 inches for use in markets outside the United States and Canada. The graphics, as demonstrated in this embodiment, are set to create the work area with an aspect ratio that matches the desired electronic standard, the options including, but not limited to, VGA, PAL, NTSC, WVGA, HD or any other standard. Additional dimensions and sizes are possible and the current preferred embodiments are not meant to exclude alternative embodiments.

An additional alternate embodiment continuing to use standard North American media standards could utilize a 14 inches in width, by approximately 8½ inches in height, by approximately 0.003 inches in thickness. Again, this would continue to work with standard office equipment, and the graphics would be set to create a work area that utilizes HD, 1080, 2K and other wider screen aspect ratios and standards. This format would utilize the footprint dimensions provided for a sheet of legal paper, to comply with office equipment standards while providing a work area that is compliant with electronic equipment and software standards.

A metric equivalent embodiment for wider standards is also possible utilizing the A scale of media sizing common in Europe and markets outside North America. Additional dimensions and dimensional relationships, representing alternate embodiments, are possible. Dimensions which permit use in standard office machines and equipment would be the preferred embodiment, although they are not intending to limit the dimensions of the current invention, especially in light of the ever evolving standards used in electronic display devices.

FIG. 2 shows a view of one possible embodiment of the rear surface of a sheet of the current invention 10, and displays a graphic pattern dissimilar to the front surface of the sheet. This embodiment illustrates an alternative graphic of the current invention with a view of the back surface of a sheet displaying a series of parallel lines across the shorter dimension of the sheet. When rotated the pattern on the opposite side of the sheet appears visually similar to a standard sheet of writing paper. Alternate embodiments the rear surface of the media could be of many different arrangements including, but not limited to, being blank, containing a pattern similar or the same as the front surface, containing alternate graphics, or containing an imbedded image different from the front side of the sheet.

FIG. 3 illustrates the side view of a sheet of the current invention 10 from the side and is shown as an indication of its thin nature. The actual thickness of a sheet of the current invention 10 is approximately 0.003″, but could be thinner or thicker depending on the specific application.

FIG. 4 illustrates an alternate embodiment of the current invention demonstrating the application of the translucent character of the Digital Interface Media, whereby when providing a backlit lighting source the translucent characteristics of Digital Interface Media provides for the visual effect of combining of the pattern on the front side of the media with the pattern on the opposite side of the sheet to create a new and useful third pattern. In this example the overlay effect combines both these separate linear patterns into the additional useful pattern of a grid. In the figure as show the gridded area inside the margins is 8 inches in width by 6 inched in height, and creates a work area with a 4:3 aspect ratio. This overlay combination of patterns is not limited to the grid pattern presented but could also be utilized for quadrille, metric, sectioned grid, crosshatch, linear, polar coordinate, as well as many others; additionally, the line separation can be modified to create different useful scales and interrelationships between the graphics on the opposing sides of the media. The embodiment described above is only one design and is not intended to preclude other applications or embodiments.

FIG. 5 illustrates an alternate embodiment of the current invention with a frontal view of a sheet displaying a pattern of more densely populated horizontally oriented lines. In this embodiment lines are of various, in this case alternating, colors providing the opportunity to use either individual or multiple lines to create a writing zone. Additionally, this embodiment demonstrates the flexibility of the media in its graphics formatting which can be modified to create a specific effect and interoperability with the graphics on the opposite surface.

FIG. 6 illustrates an alternate embodiment of the current invention with a view of a sheet displaying a pattern populated with fewer horizontally oriented lines. Additionally, as indicated in FIG. 5 above, this embodiment demonstrates the flexibility of the media in its graphics formatting which can be modified to create a specific effects, functionalities, and various interoperabilities when combined with the graphics included on the opposite surface.

FIG. 7 is a view of the current invention with the top margin area 71 highlighted. The location and dimensions of the highlighted header area are the same as those in the header and menu lines of standard computer programs.

FIG. 8 is a view of the current invention with the left side margin 81 highlighted. The location and dimensions of the highlighted left side margin area are the same as those of the side tool bars and side margins areas of standard computer programs.

FIG. 9 is a view of the current invention with the right side margin 91 highlighted. The location and dimensions of the highlighted right margin area are the same location and dimensions as the margin right margin areas of standard computer programs.

FIG. 10 is a view of the current invention with the bottom margin 101 highlighted. The location and dimensions of the highlighted area are the same as the location and dimension as those in the lower menu bar and status bar areas of standard computer programs.

FIG. 11 is a view of the current invention preferred embodiment with the primary composition and work area 111 highlighted. The dimensions and location of the highlighted area is the same as the primary work area of standard computer programs.

FIG. 12 is a view of a computer program as displayed on an electronic display device.

FIG. 13 is a view of a computer program as displayed on an electronic display with the header and menu areas 131 highlighted. The location and dimensions of the highlighted area are the same as those in the header and menu areas of standard computer programs.

FIG. 14 is a view of a computer program as displayed on an electronic display with the right and left margin areas 141 highlighted. The location and dimensions of the highlighted margin areas are the same as those in the left and right margin areas of standard computer programs.

FIG. 15 is a view of a computer program as displayed on an electronic display with the bottom menu and status bar areas 151 highlighted. The dimensions of the highlighted area are the same location and dimension as those of the lower menu and status bar areas utilized in standard computer programs.

FIG. 16 is a view of a computer program as displayed on an electronic display with the primary work area 161 highlighted. The location and dimensions of the highlighted area is the same as those in the primary composition and work area of standard computer programs.

FIG. 17 is a view of the current invention overlaid on an electronic display demonstrating the directly correlated spatial relationship between graphics provided for in the preferred embodiment of Digital Interface Media and the positioning of the program elements on the electronic display screen.

FIG. 18 is a view of the current invention overlaid on an electronic display demonstrating, in the highlighted area 181, the direct correlation between the location and dimensions of the constructed pattern in the preferred embodiment of Digital Interface Media with the location and dimensions of the software program's header and menu areas. The dimensions of the highlighted area as provided for by Digital Interface Media are the same as those in the header and menu areas of standard computer programs.

FIG. 19 is a view of the current invention overlaid on an electronic display demonstrating, in the highlighted areas 191, the direct correlation between the location, size, and dimensions of the constructed pattern in the preferred embodiment of Digital Interface Media with the location, size, and dimensions of the software program's left and right margin areas. The dimensions of the highlighted areas as provided for by Digital Interface Media are the same as those in the left and right margin areas of standard computer programs when displayed on an electronic display screen.

FIG. 20 is a view of the current Digital Interface Media invention overlaid on an electronic display demonstrating, in the highlighted area 201, the direct correlation between the location, size, and dimensions of the constructed pattern in the preferred embodiment of Digital Interface Media with the location, size, and dimensions of the software program's lower menu and status bars when displayed on an electronic display screen.

FIG. 21 is a view of the current invention overlaid on an electronic display demonstrating the relationship between the constructed patterns with the primary work area highlighted. The dimensions of the highlighted area correspond with those in the primary work zone area of standard computer programs. The dimensions, location, size, and aspect ratios of the primary work area as provided for by Digital Interface Media, highlighted at 211, are the same as those in the primary work areas of standard computer programs as displayed on an electronic display screen.

FIG. 22 is a view of the current invention with the dimensional axes 221 of the sheet indicated. The height, width, and diagonal distance are all indicated with terminuses indicating the distance and location of measurement for determining the height, width, diagonal distance and aspect ratio of the area sheet being measured. The aspect ratio used in Digital Interface Media is the same as stipulated by electronic industry standards for digital display screens, and is the same as are utilized by computer monitors and electronic display screens.

FIG. 23 is a view of the current invention with the dimensional 231 axes of the primary work area indicated. The height, width, and diagonal distance, are all indicated with terminuses indicating the distance and location of measurement for determining the height, width, diagonal distance, and aspect ratio of the primary work zone area being measured. The aspect ratio used in the primary work area Digital Interface Media is the same as the aspect ratio stipulated by electronic industry standards for digital display screens, and the same as are utilized by computer monitors and electronic display screens.

FIG. 24 is a view of the current invention demonstrating the relationship between the constructed patterns with the dimensional axes 241 of the sheet and the display area of an electronic display, with a standard software program indicated. The height, width, diagonal distance, and aspect ratio of the Digital Interface Media invention all match, are the same as, and align with the height, width, diagonal distance, and aspect ratio of the electronic display screen and the software program displayed.

FIG. 25 is a view demonstrating the relationship between the current invention, an electronic display and the software visual, with the dimensional axes 251 of the primary work area 252 created by the software indicated. The height, width and diagonal distance are all indicated with terminuses indicating the distance and location of measurement for determining the height, width, diagonal distance, and aspect ratio of the area being measured. The relationship between both the primary work area zone on the sheet and the work area of the software program on the electronic display device are demonstrated.

FIG. 26 is visual display of the primary shapes, height, width, and aspect ratios utilized by electronic display devices. In the final sample, at the bottom of the chart, the heights of the rectangles are held constant to demonstrate the relative shape and width the dimensional relationships and aspect ratios create.

FIG. 27 is visual of the primary shapes, height, width, and aspect ratios utilized by electronic display devices, presented in a transparent, layered arrangement. The heights of the rectangles are not held constant to demonstrate the relative shape and size the dimensional relationships create.

FIG. 28 is visual of the primary aspect ratio standards utilized by electronic display devices. The dimensions of the Digital Interface Media sheet and the margins included are adjusted to match these aspect ratios, and create both media and work area dimensions that match these standards. Additionally, DIM media is also constructed with size, dimension, alignment, aspect ratios for international sheet dimension standards as well as international electronic display standards. In the examples provided above the 4:3 ratio is used frequently. With this being one of the first dimensional relationships and aspect ratios utilized, it continues to be the standard for a significant number of the electronic display screens, computer software program, and application formats.

FIG. 29 is table presenting the primary aspect ratios, pixel dimensions, and relative frequency of use by electronic display devices. Again, in many of the examples provided the 4:3 ratio is used frequently. With this being one of the first and primary dimensional relationships it is frequently utilized; however, as stated above, the dimensions and ornamentation of the current Digital Interface Media invention can is not limited to that singular embodiment; DIM can be modified to match any of the indicated dimensions and aspect ratios, or any new standards that may come.

The surface characteristics and durability of the current invention 10 are important features for promoting ease of writing on the surface and good ink absorption or pigment adhesion. The preferred finish is a matte finish with good grain, such that bleeding of the ink from a felt tip, fountain, rolling ball type pen, or other writing instrument will not occur. The material stock used preferably is normal ‘paper weight’ and preferably is of about 10 lb.-50 lb. weight range, but may be heavier or lighter depending on the application.

A variety of finishes and sheet stock may be used for the current invention, preferably having an approximately equivalent feel to those described above. The surface should be one which dries ink quickly, without bleeding and which provides for pigment adhesion or absorption; and, the surface approximates flat or dull sheen.

In addition, as mentioned above, the current invention 10 can be produced in a variety of colors. Preferably light colors, and pastels, such as yellow, pale blue, pale green, pale pink, pale beige, ivory, as well as the white or off-white, each with varying levels of opacity and translucence. The surface colors are not limited to those listed; however, those listed are examples which provide good contrast for promoting the visibility of images created by normal writing instruments such as pens, pencils, markers and others.

The above described preferred embodiment is intended to illustrate the principles of the invention, but not to limit its scope. Various other embodiments and modifications to this preferred embodiment will be apparent to those skilled in the art and may be made without departing from the scope of the invention.

What I claim is:

1. A device means for use in recording and presenting information in an efficient and effective format comprising:
a) a writing surface means for recording and displaying information,
b) said writing surface is substantially planar,
c) said writing surface contains graphics to provide organizational structure,
d) said graphics are organized in a manner consistent with the orderly recording and presentation of information.

2. The writing surface of claim 1 is organized to record and present information in a format that is the same as those used by electronic display devices.

3. The writing surface of claim 1 is organized to record and present information in a format that is consistent with electronic display devices.

4. The graphics of claim 1 are organized to provide the same structure and organization that is used by software programs displayed on electronic display devices.

5. The writing surface of claim 1 is structured to use the same dimensional standards which are used by electronic display devices.

6. The writing surface of claim 1 is structured to use the same aspect ratios which are used by electronic display devices.

7. The graphics of claim 1 are structured to use the same dimensions and aspect ratios which are used by electronic display devices.

8. The graphics of claim 1 are structured to use the same dimensions and aspect ratios which are used by software programs displayed on electronic display devices.

9. A device means for use in recording and presenting information constructed of a material comprised of a translucent media.

10. The material of claim 9 shall have sufficient opaqueness to prevent graphics on the opposite side from being seen when it is front lit.

11. The material of claim 9 shall have sufficient translucence to allow graphics on the opposite side to be seen when it is back lit.

12. The material of claim 9 shall have sufficient translucence to provide for graphics on the opposite side to be visible when the media is back lit.

13. The material of claim 9 shall have sufficient translucence to provide for graphics on the opposite side to be visible in combination with the graphics on the front side when a balance in the backlight and front light (direct light) is managed.

14. A device means for comprised of a materials that interact with electromagnetic energy uniquely along the visual spectrum for use in recording and presenting information in an efficient and effective format comprising:
a) a media material that utilizes a variety of colors,
b) said media material writing utilizes a variety of shades,
c) said media material writing utilizes a variety of intensities,
d) graphics on the media utilize a variety of colors,
e) said graphics utilize a variety of shades,
f) said graphics utilize a variety of intensities.

15. The material of claim 14 shall have coloration that allows it to reflect specific colors of the visual spectrum.

16. The material of claim 14 shall have coloration that allows it to pass specific colors of the visual spectrum through it.

17. The graphics of claim 14 shall have coloration that allows it to reflect specific colors of the visual spectrum.

18. The material of claim 14 shall have coloration that allows it to pass specific colors of the visual spectrum through it.
